(19) United States
(12) Patent Application Publication
(10) Pub. No.: US 2026/0342905 A1
(43) Pub. Date: Oct. 29, 2026

(54) Mobile Phone Control System and Methods

(71) Applicant: Jason Michael Lumber, Aurora, OR (US)

(72) Inventor: Jason Michael Lumber, Aurora, OR (US)

(21) Appl. No.: 19/663,124

(22) Filed: Apr. 29, 2026

Related U.S. Application Data
(60) Provisional application No. 63/796,653, filed on Apr. 29, 2025.

(51) Int. Cl. H04M 1/72463; H04M 1/72412; H04M 1/72424; H04M 1/72457; H04W 4/029

(52) U.S. Cl. CPC H04M 1/724634; H04M 1/72412; H04M 1/72424; H04M 1/72457; H04W 4/029

(57) ABSTRACT

A mobile phone control system in which a receiving mobile phone determines that a predetermined number of calls from an initiating pre-approved emergency contact number within a predefined time interval were not answered, and automatically enters a restricted operating state limiting outgoing calls and messages to pre-approved emergency contacts and emergency services, and blocking local-network and Internet access. The receiving mobile phone automatically transmits an unlock code, a geographic location, or both, to the triggering contact. The restricted state is removed upon entry of the unlock code, completion of a voice call of at least a minimum duration with a pre-approved emergency contact, or expiration of a maximum duration. All monitoring, determining, restricting, transmitting, and removing are performed locally on the receiving mobile phone, without requiring a controlling application on a separate device, a remote server, or a cloud-based service for safety operation.

### CROSS-REFERENCE TO RELATED APPLICATIONS

This application claims the benefit of priority under 35 U.S.C. § 119(e) of U.S. Provisional Patent Application No. 63/796,653, filed Apr. 29, 2025, and titled “Mobile Phone Control System and Methods,” the entire disclosure of which is hereby incorporated by reference.

### STATEMENT REGARDING FEDERALLY SPONSORED RESEARCH OR DEVELOPMENT

Not Applicable.

### NAMES OF PARTIES TO A JOINT RESEARCH AGREEMENT

Not Applicable.

### REFERENCE TO SEQUENCE LISTING, TABLE, OR COMPUTER PROGRAM LISTING APPENDIX

Not Applicable.

### TECHNICAL FIELD

The present disclosure relates to providing a system and method for parental control of a mobile phone of a child. More particularly, the present disclosure relates to a system and method for ensuring that a phone call to the mobile phone of a child is answered.

### BACKGROUND

Mobile phones (i.e. cellular telephones) are ubiquitous in society, and most parents provide their children with mobile phones so that a parent or guardian can be assured of reaching their child in the event of an emergency, or simply to remain in contact during the course of the day. Unfortunately, either through carelessness or rebelliousness, some children will ignore a call from their parents, even after repeated attempts.

For example, a Common Sense Media survey (2018) reported that 75% of teens will avoid calls from their parents, while a Pew Research Center study (2016) reported that around 60% of parents expressed concern that their child might not answer when they call during an emergency.

Existing parental control tools for mobile phones typically fail to address behavior issues such as refusing to answer a parent's phone call. For example, while existing parental control tools may provide location tracking, application use monitoring, and even screen time limits, they all rely on cooperation, and typically require a controlling mobile phone application. Unfortunately, a reasonably technically-skilled teenager may be able to disable such applications, particularly with help from online information sources, rendering them impotent. Furthermore, such parental control applications still fail to deliver on the basic functionality of mobile phones: making and answering phone calls. Previously-known parental controls can provide no guarantee that a child will see or respond to a parent's call, especially if the child's mobile phone is set to silent, or the call is deliberately ignored.

When a child chooses not to answer their phone, the parent may feel anger and frustration, as well as being made to feel powerless, unable to contact their child in an emergency. What is needed is a mobile phone control system that provides specificity and immediacy in enforcing communication with a child, in order to ensure the safety of the child, and to avoid the frustration of being unable to reach a child.

### BRIEF SUMMARY

The present disclosure is directed to systems and methods for incentivizing a child or other dependent to answer mobile phone calls from their parent or guardian by locking the receiving mobile phone when a predetermined number of incoming calls from the same number are not answered within a predefined time interval.

In one example, the present disclosure is directed to a mobile phone control system that includes a receiving mobile phone, the mobile phone including a display, a user interface, and a processor that is configured to implement software instructions, wherein the processor of the receiving mobile phone is configured to implement software instructions for determining that a predetermined number of calls was made to the receiving mobile phone from an initiating mobile phone number, where the initiating mobile phone number is one of one or more designated mobile phone numbers, that each of the predetermined number of calls was made within a predefined time interval, and that none of the predetermined number of calls was answered; in response to determining that none of the predetermined number of calls was answered within the predefined time interval, automatically placing the receiving mobile phone into a locked state, automatically transmitting an appropriate unlock code to the initiating mobile phone number, and removing the locked state of the receiving mobile phone upon an entry of the appropriate unlock code. When the receiving mobile phone is in the locked state the receiving mobile phone cannot place an outgoing call to any telephone number other than one of the designated mobile phone numbers, cannot transmit an instant message to any number other than one of the designated mobile phone numbers, and cannot connect to a local network or an Internet, but remains capable of contacting emergency services.

In another example, the present disclosure is directed to a method of locking a receiving mobile phone, including receiving, by the receiving mobile phone, a predetermined number of calls from an initiating mobile phone number, where the initiating mobile phone number is one of one or more designated mobile phone numbers; determining, by the receiving mobile phone, that each of the predetermined number of calls from the initiating mobile phone number was received within a predefined time interval; determining, by the receiving mobile phone, that none of the predetermined number of calls from the initiating mobile phone number was answered; in response to determining that none of the predetermined number of calls from the initiating mobile phone number was answered within the predefined time interval, automatically placing the receiving mobile phone into a locked state, where when the receiving mobile phone is in the locked state the receiving mobile phone cannot place an outgoing call to any telephone number other than one of the designated mobile phone numbers, cannot transmit an instant message to any number other than one of the designated mobile phone numbers, and cannot connect to a local network or an Internet, but remains capable of contacting emergency services; and automatically transmitting, by the receiving mobile phone, an appropriate unlock code to the initiating mobile phone number, where the receiving mobile phone is configured to remove the locked state of the receiving mobile phone upon the appropriate unlock code being entered at the receiving mobile phone.

In another example, the present disclosure is directed to a mobile phone control system in which all monitoring, determining, restricting, transmitting, and removing operations are performed locally on the receiving mobile phone, without requiring a controlling application on a separate device, a remote server, or a cloud-based service for safety operation, and in which the locked state of the receiving mobile phone may be removed upon satisfaction of any one of: entry of an appropriate unlock code at the receiving mobile phone; completion of a voice call of at least a minimum duration between the receiving mobile phone and one of the pre-approved emergency contact numbers; or expiration of a predetermined maximum lockdown duration.

In a further example, the present disclosure is directed to a system in which, upon placing the receiving mobile phone into a locked state, the receiving mobile phone may automatically transmit a control signal to a network device accessible on a local network, the control signal causing the network device to restrict or disable network access for one or more connected devices; and in which the receiving mobile phone determines whether to transmit the control signal based on a comparison of one or more characteristics of a currently connected wireless network against stored network identification data.

In a further example, the present disclosure is directed to a method that further includes detecting one or more conditions indicative of an attempt to bypass the system, the conditions comprising one or more of the receiving mobile phone starting in a restricted diagnostic mode, a development or debugging interface being enabled, or the receiving mobile phone being restarted more than a predetermined number of times within a predetermined period; and, in response to detecting one or more of the conditions, automatically transmitting an alert to one or more of the pre-approved emergency contact numbers.

Additional features and advantages of the presently disclosed systems and methods will become apparent from the following drawings and description.

### BRIEF DESCRIPTION OF THE DRAWINGS

FIG. 1 is a semi-schematic illustration of an exemplary receiving mobile phone according to the present disclosure.

FIG. 2 is a semi-schematic illustration of an exemplary receiving mobile phone and an exemplary designated and/or initiating mobile phone, according to the present disclosure.

FIG. 3 is a flowchart depicting an exemplary method of locking a receiving mobile phone according to the present disclosure.

FIG. 4 is a flowchart depicting an alternative and/or additional method of locking a receiving mobile phone according to the present disclosure.

FIG. 5 is a flowchart depicting an alternative and/or additional method of locking a receiving mobile phone according to the present disclosure.

FIG. 6 is a flowchart depicting network device control during the locked state, including the comparison of currently connected wireless network characteristics against stored network identification data, the conditional transmission of a control signal to a network device upon match, and the transmission of a restore signal to the network device upon removal of the locked state, according to the present disclosure.

FIG. 7 is a flowchart depicting alternative unlock paths from the locked state, the alternative unlock paths comprising entry of an appropriate unlock code at the receiving mobile phone, completion of a voice call of at least a minimum duration with one of the pre-approved emergency contact numbers, and expiration of a predetermined maximum lockdown duration, all converging on removal of the locked state followed by initiation of a cooldown period, according to the present disclosure.

FIG. 8 is a flowchart depicting tamper detection and response, including detection of a restricted diagnostic mode, detection of a development or debugging interface being enabled, and detection of a rapid restart pattern, with automatic transmission of an alert to one or more pre-approved emergency contact numbers, and progressively increasing initialization delays in response to repeated restarts, according to the present disclosure.

FIG. 9 is a flowchart depicting a temporary boot monitoring window during which receipt of a predetermined command message from one of the pre-approved emergency contact numbers causes the receiving mobile phone to be placed into the locked state, the temporary boot monitoring window automatically closing upon expiration of a predetermined duration or upon processing of the predetermined command message, whichever occurs first, according to the present disclosure.

### DETAILED DESCRIPTION OF PREFERRED EMBODIMENTS

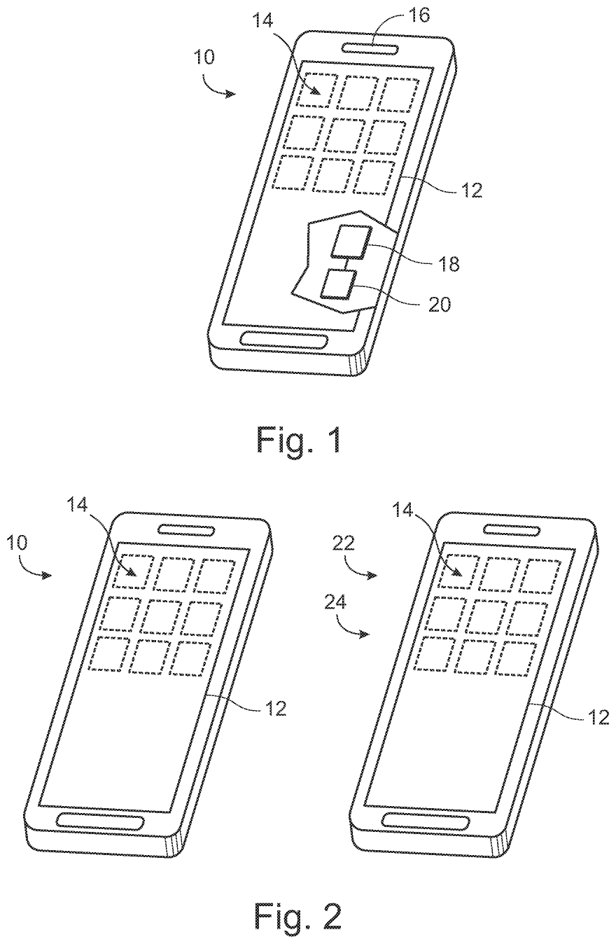

The present disclosure is directed to mobile phone control systems and methods for facilitating the locking of a mobile phone in response to repeated calls made to the mobile phone going unanswered. Advantageously, the presently disclosed control system can be implemented entirely on the mobile phone itself, so that no remote access to files, apps, usage history, or real-time location is required to function. Once a lock status is triggered for the mobile phone, the only external communication required is transmission of an unlock code being sent via SMS. In this way the mobile phone user's privacy and autonomy is protected. Furthermore, the present systems are configured so that they substantially prevent misuse of the systems for surveillance or invasive control. The systems and methods of the present disclosure permit control of a mobile phone. The mobile phone being controlled is referred to as a receiving mobile phone 10, and an exemplary and illustrative receiving mobile phone 10 is shown semi-schematically in FIG. 1.

As used herein, the term mobile phone can refer to any electronic device with cellular communication capabilities. A mobile phone may be a mobile subscriber communication device, a mobile phone, a personal digital assistant (PDA), a tablet computer, an electronic book or book reader, smart glasses (e-glasses), or other electronic device without limitation.

As used herein, a mobile device typically includes a wireless transceiver apparatus to permit communication with other systems and devices through a wireless system such as a wireless mobile telephony network, General Packet Radio Service (GPRS) network, wireless Local Area Network (WLAN), BLUETOOTH, Global System for Mobile Communications (GSM) network, Personal Communication Service (PCS) network, Advanced Mobile Phone System (AMPS) network, Infrared (IR), Near Field Communication (NFC), WIFI, IEEE 802.11 network, a Worldwide Interoperability for Microwave Access (WiMax) network, a microwave network, and/or a satellite communication network, among others. It should be appreciated that any mode of communication between a mobile device and another electronic device is an appropriate mode of communication for the purposes of the present disclosure, including a wired Internet connection, a wireless Internet connection, a cellular telephone network connection, a wireless LAN connection, a wireless WAN connection, an optical connection, a USB connection, a mobile device synchronization port connection, a power connection, and/or a security cable, among others.

The mobile phone control systems and methods for locking a mobile phone of the present disclosure may be advantageously used by a parent or guardian to incentivize a dependent child or ward to promptly answer a mobile phone call from the parent or guardian. While the present systems and methods may be particularly applicable for use by a parent in the context of a child, a parent-child relationship is not required, and any set of conditions where a guardian or person standing in loco parentis may employ the present systems and methods to ensure communication with a minor or with another individual under a guardianship or under supervision.

### Control System

As is typical for mobile phones, receiving mobile phone 10 can include a display 12 that is typically a touchscreen, where display 12 is configured to display output from receiving mobile phone 10, including stored apps, alerts and notices, and video content, among many others. Receiving mobile phone 10 additionally includes a user interface 14 that permits a user of the receiving mobile phone 10 to operate the phone. Receiving mobile phone 10 has a receiving mobile phone number, where the telephone number designates an address of receiving mobile phone 10 in a telephone network, such as the public switched telephone network (PSTN). A telephone number typically consists of, but is not limited to, a sequence of digits. Telephone numbers can facilitate the switching and routing of telephone calls using a system of destination code routing. As used herein, any calls and texts can be referred to as being sent to receiving mobile phone 10, sent to the corresponding mobile phone number for receiving mobile phone 10, or sent to the user of receiving mobile phone 10 interchangeably and without distinction.

The user interface 14 can include any number of inputs to receive commands, data, and other suitable input from a user. Typically the receiving mobile phone 10 includes one or more outputs, but typically employs display 12 or an audio speaker 16 for output to provide the user with data, notifications, and other suitable information from the receiving mobile phone 10.

In particular, while user interface 14 can include a physical keyboard or keypad, where receiving mobile phone 10 is a smartphone the user interface 14 is generally displayed and/or used in conjunction with display 12, where display 12 incorporates a touchscreen.

Receiving mobile phone 10 of FIG. 1 includes a processor 18 coupled to a memory 20 which can include volatile memory, nonvolatile memory or a combination thereof. Receiving mobile phone 10 typically further includes a communications module (not shown) that includes a wireless transceiver and a suitable power source, such as a battery (not shown).

The functionality of the receiving mobile phone 10, including the functionality and methods described herein (in whole or in part), can be implemented through processor 18 executing computer-readable instructions stored in the memory 20 of the receiving mobile phone 10.

Processor 18 can include any number and/or type of processor such as an integrated circuit microprocessor, microcontroller, and/or digital signal processor (DSP), or other suitable processing component.

Memory 20 can store any computer-readable instructions and data, including software applications, applets, and embedded operating code. Any software application used to carry out the functionality and methods described herein can also be hidden and/or locked in such a way that the software application cannot be halted or deleted by a user of the receiving mobile phone.

The memory 20 can store instructions, data, messages transmitted from (or received by) the receiving mobile phone 10, and any other suitable information. Memory 20 can include any combination of different memory storage devices, including volatile and/or nonvolatile memory, such as flash memory, ROM, PROM, EPROM, EEPROM, dynamic random-access memory (DRAM), and static random-access memory (SRAM), among others. Data can be stored in the memory 20 in any desired manner.

Systems and methods for controlling the receiving mobile phone 10 are presented in the context of at least one receiving mobile phone 10, and at least one designated mobile phone 22, as shown in FIG. 2. As will be discussed below, the present systems and methods can include a plurality of designated mobile phones 22. When the present disclosure refers to “a” designated mobile phone 22 or “the” designated mobile phone 22, this should be considered to explicitly include any or all of a plurality of such designated mobile phones 22. Each designated mobile phone 22 has a corresponding designated mobile phone number, and at least one user. As used herein, any calls and texts can be referred to as being sent to designated mobile phone 22, sent to the corresponding mobile phone number for designated mobile phone 22, or sent to the user of designated mobile phone 22 interchangeably and without distinction.

A mobile phone is a designated mobile phone 22 when the mobile phone number of that mobile phone is included in a listing of designated mobile phone numbers for receiving mobile phone 10. The listing of designated mobile phone numbers is created during setup of the present system, and corresponds to those mobile phones that are able to activate the present system. That is, the designated mobile phone numbers have been “designated” to be a component of the present system. In one aspect, a user of a designated mobile phone 22 can be any person with a need or desire to maintain communication with the user of receiving mobile phone 10, such that the presently disclosed systems and methods can be used to ensure that the user of receiving mobile phone 10 will answer an incoming phone call from a designated mobile phone 22. In this example, a user of designated mobile phone 22 is typically a parent or a guardian of the user of receiving mobile phone 10, but is not limited thereto, and the user of receiving mobile phone 10 can be a child, a minor, or a ward, but is not limited thereto.

In another aspect of the present system and method, a user of a designated mobile phone 22 may be included in the listing of designated mobile phone numbers for receiving mobile phone 10 because it may be deemed important that the user of receiving mobile phone 10 maintain an ability to contact that user, even when the present system is active and receiving mobile phone 10 is otherwise in a locked state, as will be discussed below. The listing of designated mobile phone numbers may include parents, siblings, aunts, uncles, or other family members, or even trusted friends, at the discretion of the user setting up the present system on receiving mobile phone 10.

The listing of designated mobile phone numbers is therefore a pre-approved list of contacts. In one aspect, the listing of designated mobile phone numbers can be referred to as an emergency contact list, or a pre-approved emergency contact list, and each mobile phone number included in the listing of designated mobile phone numbers can be referred to as a pre-approved emergency contact number, even if they do not strictly correspond to emergency services. In theory there can be any number of contacts included in the listing of designated mobile phone numbers, but it may be more practical to limit the number of such designated mobile phone numbers. In one aspect of the present disclosure, the disclosed systems and methods may permit up to four mobile phone numbers to be included in the listing of phone number of designated mobile phones 22.

As used herein, the terms “designated mobile phone,” “designated mobile phone number,” “pre-approved emergency contact,” and “pre-approved emergency contact number” are used interchangeably. Each refers to a mobile phone or mobile phone number that has been included in a pre-selected listing of mobile phone numbers configured during setup of the present system. The original 17 claims of this disclosure use the terms “designated mobile phone” and “designated mobile phone number,” while certain additional claims and description paragraphs of this disclosure use the terms “pre-approved emergency contact” and “pre-approved emergency contact number.” Both sets of terms are equivalent in scope and meaning, and reference to either set is intended to encompass the other.

By virtue of being included in the pre-selected (pre-approved) listing of designated mobile phone numbers, incoming phone calls to receiving mobile phone 10 from designated mobile phone 22 can activate the presently disclosed system. More specifically, the processor 18 of receiving mobile phone 10 is configured to implement software instructions in order to carry out at least the following operations: determining that a call is made to receiving mobile phone 10 from one of the designated mobile phone numbers; and determining that the call from the designated mobile phone number was not answered by the receiving mobile phone 10. The processor 18 is further configured to determine that a second and/or subsequent calls making up a predefined number of calls was made to receiving mobile phone 10 from the same designated mobile phone number within a predefined time interval; and to determine whether or not any of the predefined number of calls from the designated mobile phone number were answered. If none of the predetermined number of calls from the designated mobile phone number was answered within the predefined time interval, processor 18 is configured to automatically place receiving mobile phone 10 into a locked state. When receiving mobile phone 10 is placed into a locked state, the mobile phone from which the initiating calls were made (which is, by definition, a designated mobile phone number) becomes an initiating mobile phone number, corresponding to an initiating mobile phone 24. The initiating mobile phone 24 can also be referred to as a triggering emergency contact.

The predetermined number of calls from a designated mobile phone 22 that may be unanswered before the mobile phone is automatically placed into a locked state is typically selectable during setup of the present system, and may be any desired number of missed calls. Typically, the predetermined number of missed calls is from 2-5. In a particular embodiment of the present disclosure, the predetermined number of missed calls is 2.

Similarly, the predefined time interval within which the predefined number of calls is received is typically selectable during setup of the present system, and may be any desired time interval. Typically, the predefined time interval is 1-10 minutes. More typically, the predefined time interval is 2-5 minutes.

The processor 18 of receiving mobile phone 10 can be further configured so that when receiving mobile phone 10 is placed in the locked state, the receiving mobile phone can display a missed call notification on display 12. Such a missed call notification can include any desired information, but may typically include a statement such as “You have one missed call,” or “Your next missed call will result in your device being locked” and/or a display of the identity of the user of the initiating mobile phone 24, and a suggestion to call the user of the initiating mobile phone. The present system may be configured so that a missed call notification is automatically removed after the expiration of the predetermined time interval from the first missed call.

The receiving mobile phone 10 is typically configured so that when receiving mobile phone 10 is placed into the locked state, receiving mobile phone 10 automatically transmits an appropriate unlock code to initiating mobile phone 24. That is, the appropriate unlock code is automatically transmitted to the designated mobile phone 22 from which the unanswered calls were made. The unlock code is not revealed to the user of receiving mobile phone 10.

An appropriate unlock code is typically randomly generated when it is needed, and can include letters, numbers, or special characters, or a common word or phrase. Typically, a generated unlock code is unique, and is appropriate for (or corresponds to) a particular lock state for a particular receiving mobile phone 10. If the appropriate unlock code is subsequently received by receiving mobile phone 10, the locked state of receiving mobile phone 10 is removed.

As the appropriate unlock code is transmitted automatically to initiating mobile phone 24, the user of receiving mobile phone 10 is unable to enter the appropriate unlock code (and unlock their phone) unless they have obtained the unlock code from the user of initiating mobile phone 24. This incentivizes the user of receiving mobile phone 10 to contact the user of initiating mobile phone 24, whose incoming calls they have not answered. As a result, it is likely that communication will be established between the user of initiating mobile phone 24 and the user of receiving mobile phone 10, which was an original intention of the unanswered triggering mobile phone calls. Such communication can be particularly important where an emergency has occurred, or where time-sensitive information must be obtained by the user of initiating mobile phone 24. But it is the reestablishment of communication that is the preferred goal of the presently disclosed system, rather than punishment, or to serve as remote supervision, regardless of the particular nature of the originally desired communication.

When receiving mobile phone 10 is placed into a locked state, receiving mobile phone 10 is prevented from placing an outgoing call to any telephone number other than one of the pre-approved designated mobile phone numbers, and cannot transmit an instant message to any telephone number other than one of the designated mobile phone numbers. Similarly, while the receiving mobile phone 10 can remain connected to a local communication network or an Internet, so as to remain in contact with initiating mobile phone 24, the user of receiving mobile phone 10 is prevented from accessing the local communication network or Internet for substantially any purpose other than contacting a designated mobile phone, particularly initiating mobile phone 24. As an exception, in every event and even when in the locked state, receiving mobile phone 10 remains capable of contacting emergency services if needed, such as 911.

Receiving mobile phone 10 will remain in a locked state until the appropriate unlock code is entered into the phone by the user of receiving mobile phone 10, where the appropriate unlock code is the randomly-generated code that was transmitted to the initiating mobile phone 24 when receiving mobile phone 10 was placed into a lock condition. As the presently disclosed system is configured and intended to operate, the appropriate unlock code should be obtained by the user of receiving mobile phone 10 by calling the initiating mobile phone 24 and requesting it. Typically, the appropriate unlock code is provided to the user of mobile phone 10 verbally in a voice call, providing the user of the initiating mobile phone 24 the desired contact and communication with the user of mobile phone 10. Alternatively, or in addition, the appropriate unlock code may be transmitted by SMS, or any other suitable method, if the user of the initiating mobile phone 24 agrees to do so.

Processor 18 of receiving mobile phone 10 is further configured so that after receiving mobile phone 10 is placed into the locked state, receiving mobile phone 10 can display a locked state notification. Such a locked state notification can include any desired information, such as “Your device is locked,” or “You have not answered X calls from (initiating mobile phone number),” and/or a notice that the user of the receiving mobile phone must call the initiating mobile phone number in order to get their device unlocked.

Entering the appropriate unlock code into receiving mobile phone 10 can result in receiving mobile phone 10 being returned to an unlocked state. The receiving mobile phone 10 is further configured so that if an incorrect unlock code (i.e. an inappropriate unlock code) is entered at receiving mobile phone 10, the mobile phone will not be unlocked. Optionally, mobile phone 10 is further configured so that an attempt to enter an incorrect unlock code can trigger the transmission of a newly-generated appropriate unlock code to initiating mobile phone 24. During setup, receiving mobile phone 10 may be configured so that an incorrect code must be entered a predetermined number of times before the transmission of a new appropriate unlock code. In one aspect, an incorrect unlock code must be entered from one to three times before the transmission of a new appropriate unlock code to initiating mobile phone 24. Additionally or alternatively, the attempted entry of an incorrect unlock code one or more times can result in the display by receiving mobile phone 10 that an incorrect attempt has been made.

Upon removal of the locked state of receiving mobile phone 10, a cooldown period may be initiated during which the system will not re-enter the locked state in response to additional unanswered calls from any designated mobile phone 22. This cooldown prevents a situation where the locked state is immediately re-triggered after being removed, which could constitute a form of harassment or abuse of the system by a user of a designated mobile phone 22. The cooldown period is typically brief, such as one to five minutes, and may be configurable during setup.

Entry of an incorrect unlock code a predetermined number of times at receiving mobile phone 10 may result in a temporary lockout period during which no further unlock code entries are accepted. This rate limiting mechanism prevents brute-force attempts to guess the unlock code. Typically, the number of permitted incorrect attempts is 2-5, and the lockout period is 1-10 minutes. Both the number of permitted attempts and the lockout duration may be configurable during setup. The lockout state persists across restarts of the receiving mobile phone 10 so that powering off and powering on the phone does not reset the attempt counter.

In a further aspect of the presently disclosed system, receiving mobile phone 10 can be further configured so that when receiving mobile phone 10 is placed in a locked state, processor 18 automatically transmits a single GPS location pin to initiating mobile phone 24. The GPS location pin reflects the location of receiving mobile phone 10 at the time it was placed in a lock status. The GPS location pin can be transmitted via SMS or other messaging system. Typically, receiving mobile phone 10 can be configured so that each time mobile phone 10 is placed in a locked state as a result of missing repeated calls from a designated mobile phone 22, receiving mobile phone 10 automatically transmits a corresponding GPS location pin to the appropriate initiating mobile phone 24. In this way the location of receiving mobile phone 10 (and the user of receiving mobile phone 10) can be monitored without enabling continuous location tracking or saving location data, and thereby avoiding a violation of the privacy of the user of receiving mobile phone 10.

In another aspect of the present disclosure, if receiving mobile phone 10 is taken offline, or powered off when it was, or would have been, placed into a locked state, the system will capture and transmit a single GPS location pin when connectivity and power are restored and a new locked state event occurs. The system does not queue multiple location updates, store location history, or accumulate unsent messages for later delivery. Each locked state event generates at most one GPS location fix, captured at the time the event is initiated or at the time connectivity is restored, whichever is later.

In another aspect of the present disclosure, the present system can provide a further incentive for the user of receiving mobile phone 10 to contact initiating mobile phone 24. Specifically, processor 18 of receiving mobile phone 10 can be further configured so that when receiving mobile phone 10 is placed into the locked state, an additional lock signal can be transmitted by receiving mobile phone 10 that is directed to one or more additional electronic devices, with the result that the one or more additional electronic devices are also placed into a locked state.

The one or more additional electronic devices can include any desired electronic device, but can typically include an electronic device that is selected because removing its availability will be a disincentive to the user of the receiving mobile phone. For example, the additional electronic devices can include one or more of an additional mobile phone, an electronic tablet, a personal computer, and a gaming console, among others. Where the additional electronic device is a smart device, such as a smart watch, tablet, or computer, being placed in lock status can result in the display of only limited information, and/or the display of limited options for a user. In some cases, an electronic device can be placed into a lock status by altering the function of a local router, disabling an Internet connection.

### Network Device Control During the Locked State

In a further aspect of the present disclosure, the one or more additional electronic devices placed into a locked state as described above may include a network router or other network access device accessible to receiving mobile phone 10 via a local network connection. In this embodiment, when receiving mobile phone 10 is placed into a locked state, processor 18 may automatically transmit a control signal to the network router via the local network, causing the network router to disable or restrict a wireless network, such as a guest wireless network, thereby preventing other devices (such as tablets, gaming consoles, personal computers, and other devices connected to the guest network) from accessing the Internet through that network. This provides an additional incentive for the user of receiving mobile phone 10 to contact the user of initiating mobile phone 24, as network access for their other devices is also restricted during the lockdown period.

Receiving mobile phone 10 may determine whether to transmit the control signal based on whether the receiving mobile phone is currently connected to a wireless network matching stored network identification data. Such network identification data may include one or more of a network name (e.g. SSID), a hardware address of a wireless access point (e.g. BSSID or MAC address), or a network gateway address (e.g. default gateway IP address). During initial setup, a user of a designated mobile phone 22 may configure one or more home network locations, each associated with a specific emergency contact and a specific network device. By comparing the current wireless network characteristics of receiving mobile phone 10 against the stored network identification data, the system can determine whether the receiving mobile phone is at a location where a configured network device is available. If the receiving mobile phone is at an unfamiliar location (such as a school, workplace, or friend's house), the system skips network device control entirely because there is no configured network device at that location.

Network device control may be implemented through one or more of: direct HTTP or HTTPS communication with the network device's administrative interface, brand-specific control protocols tailored to particular network device manufacturers, or generic form-based interaction with the device's web interface. The system may support a plurality of network device manufacturers and may select an appropriate control method based on a brand identifier stored during setup. Communication with the network device may include authentication using stored administrator credentials, which are encrypted on receiving mobile phone 10 using hardware-backed encryption.

If direct network control is unavailable or unsuccessful (for example, if the network device's administrative interface is unreachable, or if the device does not support guest network control), the system may employ a fallback strategy, such as activating parental control or device-pausing features of the network device that achieve a similar restriction of network access through alternative means. The system may attempt multiple control strategies in sequence until one succeeds or all are exhausted.

Upon removal of the locked state of receiving mobile phone 10, the system may automatically transmit a restore signal to the network device, causing it to re-enable the previously disabled wireless network or deactivate the previously activated parental controls, thereby restoring normal network connectivity for devices that were restricted during the lockdown period.

### Boot Window Lock Command

In addition to automatically placing receiving mobile phone 10 into a locked state if multiple incoming calls from a designated mobile phone 22 are not answered, the system of the present disclosure may be further configured so that if receiving mobile phone 10 is turned off (i.e. powered down) so that incoming calls from a designated mobile phone 22 are prevented from being technically unanswered, the user of the designated mobile phone 22 can send a message via SMS to the receiving mobile phone 10 with a simple message such as “LOCK”. When receiving mobile phone 10 is again turned on and checks for received text messages, the receipt of the “LOCK” message from a designated mobile phone 22 will immediately and automatically place receiving mobile phone 10 into a locked state that can be removed as discussed above.

The temporary monitoring window described in paragraph [0065] above, during which the predetermined command message (such as “LOCK”) can trigger the locked state, has a configurable but limited duration, typically not exceeding several minutes. This time limitation is a deliberate anti-abuse measure that prevents a user of a designated mobile phone 22 from remotely triggering the locked state of receiving mobile phone 10 at arbitrary times. If the monitoring window were open indefinitely, a parent could text “LOCK” at any time to remotely lock the child's phone, which would transform the system from a communication accountability tool into a remote control tool, undermining the core design philosophy of the present invention. The monitoring window closes automatically upon expiration of its predetermined duration or immediately upon processing a valid command message, whichever occurs first. The window cannot be reopened without a full restart of receiving mobile phone 10. Outside of this temporary window, the locked state can only be triggered by unanswered calls as described above, ensuring that the system enforces communication accountability rather than enabling arbitrary remote control.

It may be that a given parent or guardian has multiple children or other dependents with whom they wish to promote prompt communication. This is readily achieved using the presently disclosed system, as each child can have the presently disclosed system set up and activated on their mobile phone. The systems can operate independently of each other, and each system can have its own predefined time intervals and triggering number of unanswered calls, perhaps to reflect a degree of responsibility exhibited by each user.

### Alternative Unlock Mechanisms

The control systems of the present disclosure can be installed directly, and exclusively, on receiving mobile phone 10. While a parent or guardian necessarily must install and set up the conditions for operation of the system, the presently disclosed systems do not provide remote access to the receiving mobile phone 10. Other than receiving a single GPS location pin via SMS when receiving mobile phone 10 is placed in a locked state, the parent or guardian is not able to track the location of receiving mobile phone 10, and cannot monitor its use. Additionally, the present control systems are typically configured so that receiving mobile phone 10 is placed in a lock status only as a result of failing to answer a predetermined number of incoming calls from a designated mobile phone 22. In this way the parent or guardian is prevented from abusing or harassing the user of receiving mobile phone 10, helping to protect the user's privacy and autonomy.

In various embodiments, the locked state of receiving mobile phone 10 may be removed through one or more alternative mechanisms in addition to entry of the appropriate unlock code described above. In one embodiment, the locked state is removed when the user of receiving mobile phone 10 places a voice call to one of the pre-approved emergency contact numbers associated with a designated mobile phone 22 and the call is maintained for at least a minimum duration, such as 30 seconds or more. This alternative unlock mechanism directly serves the core purpose of the present system: reestablishing actual voice communication between the user of receiving mobile phone 10 and a trusted contact. The minimum call duration is configurable during setup and is typically set to a duration sufficient to ensure that a meaningful conversation has occurred, rather than a momentary connection. The system may monitor the call state of receiving mobile phone 10 and automatically remove the locked state when a qualifying call ends. The qualifying voice call may be an outgoing call placed by receiving mobile phone 10 to a designated mobile phone 22, or an incoming call from a designated mobile phone 22 that is answered by receiving mobile phone 10 during the locked state and maintained for at least the minimum duration.

In another embodiment, the locked state is automatically removed after a predetermined maximum lockdown duration, regardless of whether the appropriate unlock code has been entered or a qualifying voice call has been completed. This automatic release mechanism serves as a safety limitation that prevents indefinite restriction of receiving mobile phone 10. The maximum lockdown duration may be configured during setup and may be any desired period, but is typically not less than several hours (for example, 6 to 24 hours). In a particular embodiment, the maximum lockdown duration is 12 hours. The automatic release mechanism cannot be disabled by any user, including the user who set up the system. This ensures that the present system cannot be used as a tool for indefinite device restriction, which could constitute abuse. The automatic release is implemented using a scheduled background task that fires regardless of whether receiving mobile phone 10 is actively in use, in a sleep state, or has been restarted since the locked state was initiated.

The system may employ any combination of unlock mechanisms simultaneously, such that the locked state is removed upon the first satisfaction of any configured unlock condition. For example, the locked state may be configured to end upon: (a) entry of the appropriate unlock code, or (b) completion of a voice call of at least 30 seconds to an emergency contact, or (c) expiration of 12 hours, whichever occurs first. This multi-path unlock design provides flexibility and ensures that the user of receiving mobile phone 10 always has a means of restoring normal device operation, even in edge cases such as loss of SMS delivery, unavailability of a specific emergency contact, or other failure conditions.

### Tamper Detection and Countermeasures

The control system of the present disclosure can be implemented on any suitable mobile phone system. The control system can be used in the iOS environment by taking advantage of, for example, Guided Access, CallKit developer toolkit, and the Core Location Framework developer toolkit, among others. The control system can be used in the Android environment by taking advantage of, for example, Device Management APIs, TelephonyManager, and the Fused Location Provider API, among others. Typically such location APIs would be used to obtain a location of receiving mobile phone 10 at the time a locked state is initiated, which can then be sent to designated mobile phone 22 as a GPS location pin. Receiving mobile phone 10 need not actively track mobile phone location.

The processor 18 of receiving mobile phone 10 may be further configured to detect conditions indicative of an attempt to bypass or disable the present system. Such conditions may include, without limitation: the receiving mobile phone starting in a restricted diagnostic mode (commonly known as “Safe Mode” on certain mobile operating systems) that disables all third-party applications, including the present system, while the operating system continues to run; a development or debugging interface (commonly known as “USB Debugging” or “Developer Mode”) being enabled on receiving mobile phone 10, which could allow an external computer or tool to manipulate the system's operation; or the receiving mobile phone being restarted an excessive number of times within a short period (for example, more than three times within ten minutes), which may indicate a deliberate attempt to exploit restart behavior or timing windows.

Upon detecting one or more of these conditions, processor 18 may automatically transmit an alert message to one or more of the pre-approved emergency contact numbers associated with designated mobile phones 22, informing the associated users that a potential bypass attempt has been detected on receiving mobile phone 10. The alert message may be transmitted via SMS or other messaging mechanism available on receiving mobile phone 10, and may include information about the specific condition detected (for example, “Safe Mode detected” or “USB Debugging enabled”). This allows the user of the designated mobile phone 22 to take appropriate action, such as contacting the user of receiving mobile phone 10 or physically accessing the device to investigate.

To discourage repeated restarts as a bypass technique, the system may implement progressively increasing delays between system initialization and full system activation upon detecting a pattern of rapid restarts. For example, if receiving mobile phone 10 is restarted twice within five minutes, the system may delay full activation by 30 seconds after the second restart; if restarted a third time within the same period, the delay may increase to 90 seconds; and so on, following an exponential backoff pattern. This makes repeated restarts increasingly ineffective as a bypass strategy, as each successive restart results in a longer period during which the child must wait before the phone is fully usable, while the monitoring system still activates before the phone becomes available for general use.

### Uninstall Protection and Device Administrator Registration

The software instructions implementing the present system may be registered as a device administrator on receiving mobile phone 10, such that deactivation of the device administrator privilege is required prior to removal of the software instructions. In an Android environment, this registration may be implemented through the Android Device Administrator framework. Attempted deactivation of the device administrator privilege may be intercepted by the system, and a notification of the attempted deactivation may be automatically transmitted to one or more of the pre-approved emergency contact numbers. The user of receiving mobile phone 10 retains the ability to ultimately remove the system through standard operating system uninstallation procedures, but the device administrator registration imposes an additional explicit step (deactivation of the administrator privilege) and triggers an alert to the parent or guardian, making casual or impulsive uninstallation less likely and providing the parent or guardian with advance notice of the attempted removal.

### Multiple Detection Methods for Unanswered Calls and Command Messages

Internet access for the mobile phones can be controlled via router API integration, offering privacy and security. For example, all communications to and from the receiving mobile phone and designated mobile phone could be end-to-end encrypted, and any processing of sensitive data can be processed locally.

The system may detect unanswered calls from designated mobile phones 22 through multiple methods, and may employ these methods in a prioritized sequence depending on the capabilities and restrictions of the particular device and operating system version. In one embodiment, the system detects unanswered calls by monitoring notifications generated by the device's telephony application, reading caller identification information from the notification metadata, and comparing the identified caller against the listing of designated mobile phone numbers. This method does not require direct access to the device's call log database, and is suitable for environments where call log access is restricted by the operating system or by application distribution platform policies. In another embodiment, the system registers with a call screening interface provided by the operating system to receive real-time call event data, including the caller's phone number, for each incoming call. The system uses this information to identify calls from designated mobile phones 22 and to track whether such calls are answered. In yet another embodiment, the system queries the device's call log database after detecting a call state transition (such as a transition from a ringing state to an idle state without an intervening connected state) to determine whether the call was from a designated mobile phone 22 and was not answered. The system may employ any combination of these methods simultaneously, and may fall back from a preferred method to an alternative method if the preferred method is restricted, unavailable, or unreliable on a particular device.

Similarly, the system may detect the receipt of a command message (such as the “LOCK” command described in paragraph [0065] above) through multiple methods, including monitoring device notifications for new messages from designated mobile phones 22, registering to receive message events directly from the operating system's messaging framework, or employing accessibility features of the device to detect the appearance of new message content in the notification area. The system may employ one or more of these detection methods based on the capabilities and restrictions of the particular device, operating system, and application distribution channel.

### Message Deduplication and Counter Persistence

The system may be further configured to ensure that messages transmitted upon entering the locked state are transmitted exactly once per locked state event. Such messages may include, without limitation, the appropriate unlock code and the GPS location pin. To prevent duplicate transmissions resulting from system restarts, retries, or race conditions in concurrent execution paths, the system may employ one or more deduplication mechanisms. In one embodiment, a session-based flag is set when the message is first sent for a given locked state event, and subsequent send attempts for the same event are suppressed when the flag is detected. In another embodiment, a duplicate-window mechanism tracks recently sent messages by recipient and content for a defined window (for example, five minutes), and identical messages directed to the same recipient within the window are suppressed. In a further embodiment, the system imposes a per-recipient rate limit (for example, three messages per minute per recipient) to prevent any runaway sending scenario. These mechanisms may be employed individually or in combination to guarantee exactly-once delivery of locked-state messages even in the presence of mid-send restarts, background-worker retries, or duplicate triggers.

The count of unanswered calls and the timestamps of those calls may be persisted in encrypted storage on receiving mobile phone 10 such that powering off and powering on the receiving mobile phone does not reset the count. Without persistence of the count across restarts, a user of receiving mobile phone 10 could simply restart the device between unanswered calls to reset the counter and prevent the locked state from ever being triggered. Persistent storage may be implemented using hardware-backed encryption (for example, a hardware-backed keystore on a mobile operating system) and platform-provided encrypted preferences. Counter data older than a defined age (for example, 24 hours) may be periodically purged to prevent unbounded storage growth, while data within the active monitoring window is preserved across restarts.

### Lockdown User Interface Overlay

In one aspect of the present disclosure, placing receiving mobile phone 10 into the locked state may include rendering a lockdown user interface that is displayed above other applications running on receiving mobile phone 10, including a default home screen launcher, application icons, and any third-party applications. The lockdown user interface may be implemented as a system-level overlay window or other mechanism provided by the operating system of receiving mobile phone 10, configured to intercept touch input directed to user-interface elements of receiving mobile phone 10 other than controls for placing a call to a designated mobile phone 22 or initiating mobile phone 24, controls for entering the appropriate unlock code, and controls for contacting emergency services. This overlay-based implementation ensures that, while in the locked state, the user of receiving mobile phone 10 cannot navigate to other applications, launch background tasks, or interact with the device for any purpose unrelated to the limited communications permitted during the locked state. The lockdown user interface may include a numeric or alphanumeric input field for entering the appropriate unlock code, one or more dialing controls for the pre-approved emergency contact numbers, and a dialing control for emergency services. Upon removal of the locked state, the lockdown user interface is dismissed and receiving mobile phone 10 returns to its prior operational state. In a particular embodiment, the lockdown user interface may temporarily suspend its overlay function for a short interval (for example, 250 milliseconds) at the moment a call is placed to a designated mobile phone 22 or to emergency services, to permit the operating system's native dialer interface to receive user input, after which the lockdown user interface resumes its overlay function. Alternative implementations of the lockdown user interface may include kiosk-mode features of the operating system, accessibility-service-based mechanisms, or guided-access features of the operating system, where available.

### Methods

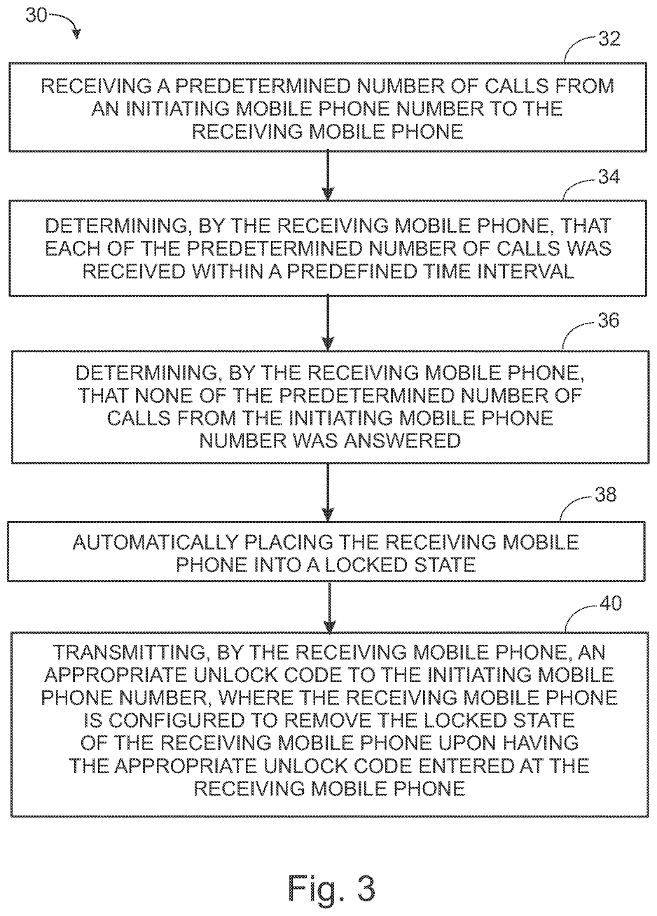

The phone control system of the present disclosure is particularly well-suited for carrying out a method of locking a receiving mobile phone, as set out in flowchart 30 of FIG. 3. As shown, the method can include receiving, by the receiving mobile phone, a predetermined number of calls from an initiating mobile phone number, at 32 of flowchart 30; determining, by the receiving mobile phone, that each of the predetermined number of calls was received within a predefined time interval, at 34 of flowchart 30; determining, by the receiving mobile phone, that none of the predetermined number of calls from the designated mobile phone number was answered, at 36 of flowchart 30; automatically placing the receiving mobile phone into a locked state, at 38 of flowchart 30; and automatically transmitting, by the receiving mobile phone, an appropriate unlock code to the designated mobile phone number, where the receiving mobile phone is configured to remove the locked state of the receiving mobile phone upon the appropriate unlock code being entered at the receiving mobile phone, at 40 of flowchart 30.

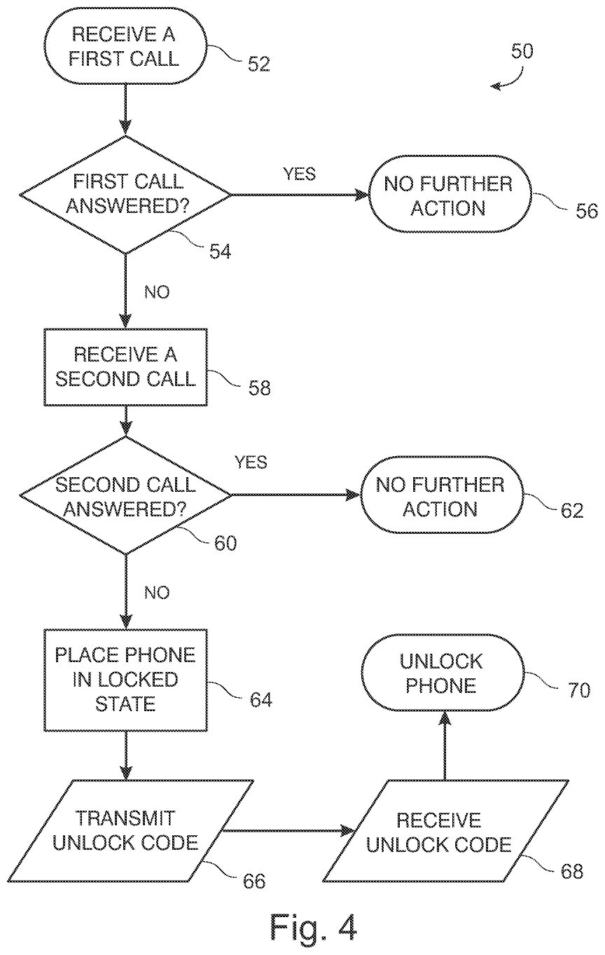

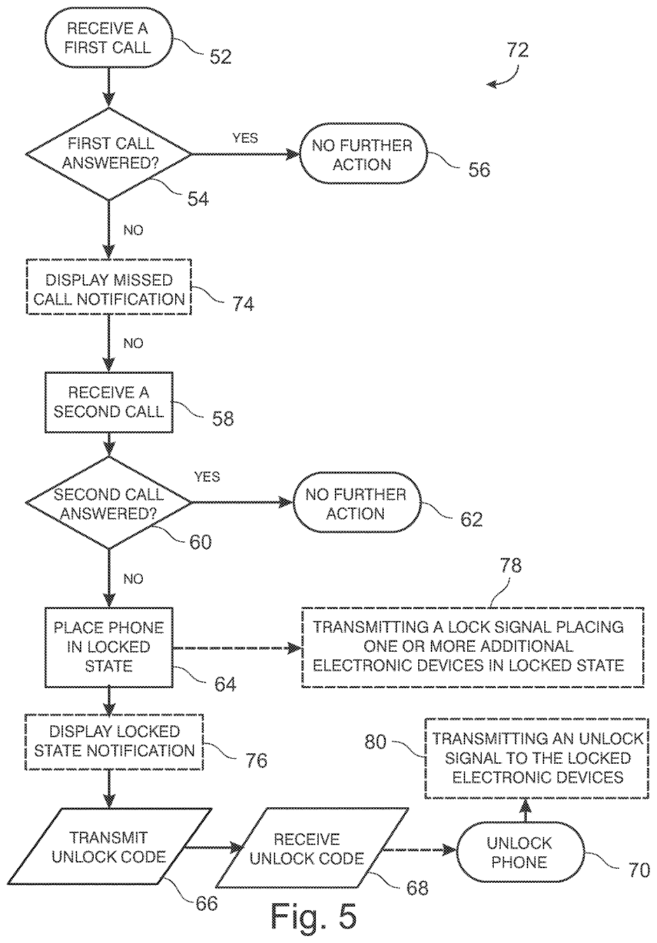

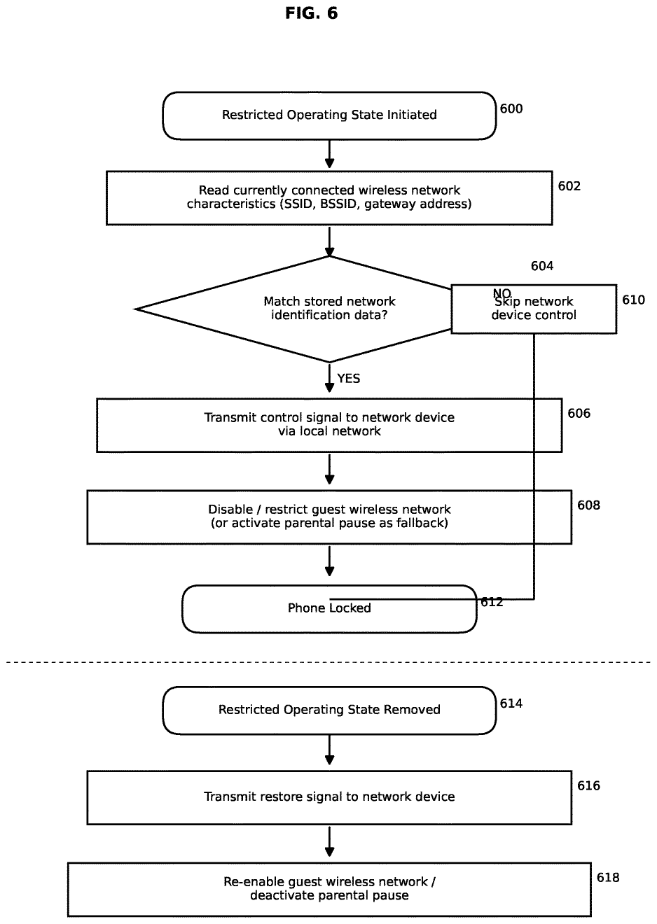

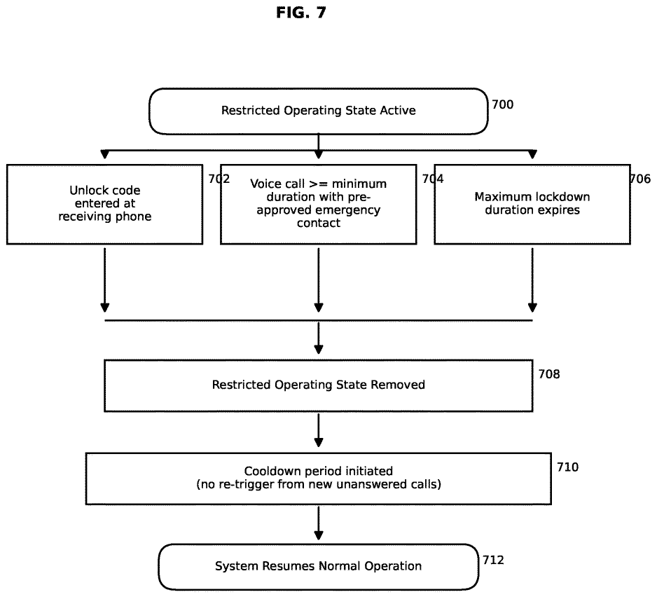

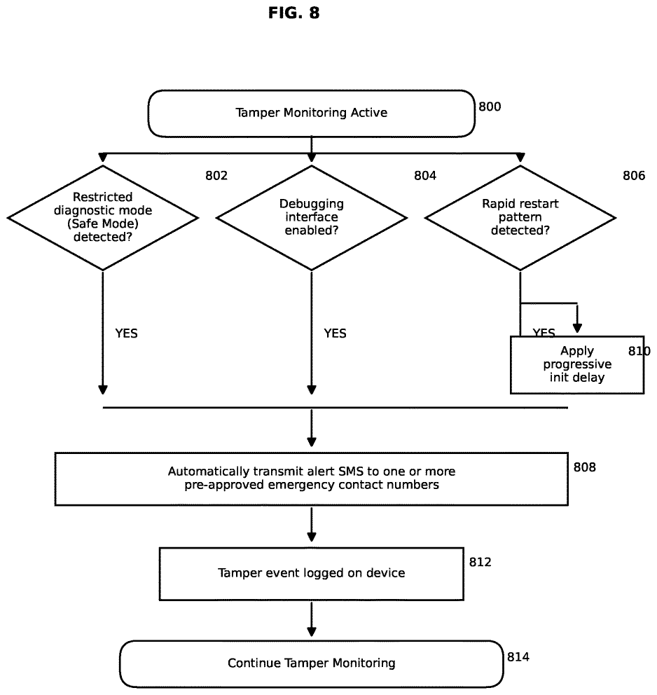

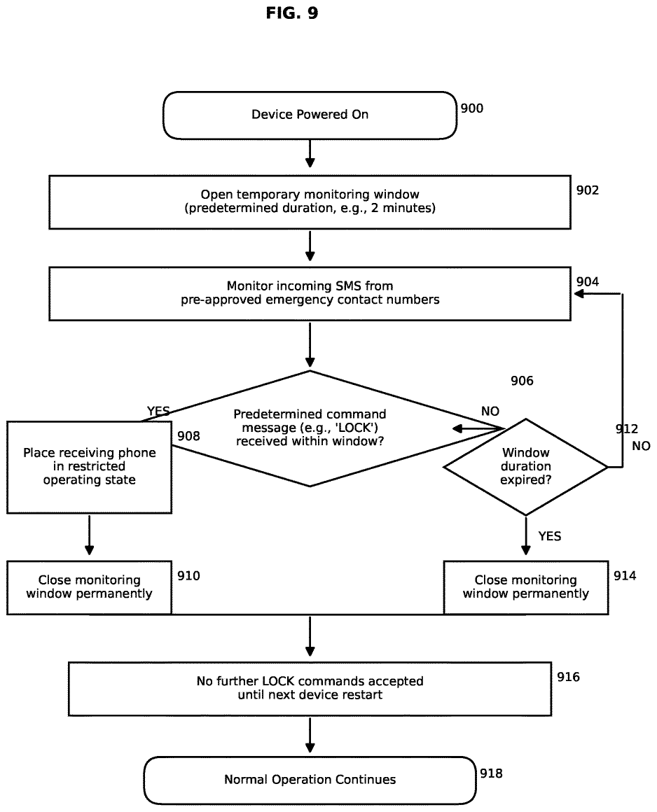

FIGS. 4 and 5 depict additional flowcharts showing alternative illustrative examples of the method of the present disclosure. For the sake of simplicity, each of flowcharts 50 and 72 of FIGS. 4 and 5, respectively, depicts an example of a method where the predetermined number of calls to be received before the receiving mobile phone is locked is 2 calls.

Similar to flowchart 30 of FIG. 3, flowchart 50 of FIG. 4 shows that if receiving mobile phone 10 receives a first call from a designated mobile phone (at 52), and the first call is answered (at 54), no further action is needed (at 56). If the first call is not answered but a second call from the designated mobile phone is received (at 58) and answered (at 60), no further action is needed (62). However, if neither the first call nor the second call are answered, the phone is placed into a locked state (at 64) and the appropriate unlock code is transmitted to the designated mobile phone (at 66). If the appropriate unlock code is provided by the user of the designated mobile phone, by phone call or text message, the unlock code can then be entered into the receiving mobile phone (at 68), and the phone can be placed into an unlocked state (70).

The disclosed method can include one or more additional steps or processes, without limitation, such as is shown at 74 of flowchart 72, which includes the receiving mobile phone displaying a notification that a first incoming call from the designated mobile phone has not been answered. Alternatively, or in addition, the receiving mobile phone can display a notification that the receiving mobile phone has been placed in a locked state, at 76 of flowchart 72. Alternatively, or in addition, the disclosed method can include transmitting a lock signal that places one or more additional electronic devices into a locked state at 78 of flowchart 72. Where one or more additional electronic devices have been placed into a locked state, upon unlocking the receiving mobile phone an unlock signal can then be transmitted to the locked additional electronic devices, at 80 of flowchart 72, placing them into an unlocked state.

Although the systems and methods disclosed herein have been shown and described with reference to the foregoing operational principles and preferred embodiments, it will be apparent to those skilled in the art that various changes in form and detail can be made without departing from the spirit and scope of the invention. The present invention is intended to embrace all such alternatives, modifications and variances that fall within the scope of the appended claims.

The subject matter of the present disclosure includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

Inventions embodied in various combinations and subcombinations of features, functions, elements, and/or properties can be claimed through presentation of new claims in a related application. Such new claims, whether they are directed to a different invention or directed to the same invention, whether different, broader, narrower or equal in scope to the original claims, are also regarded as included within the subject matter of the inventions of the present disclosure.

The methods, systems, and operations described herein may be embodied as instructions stored on a non-transitory computer-readable medium of receiving mobile phone 10. Such non-transitory computer-readable medium may include, without limitation, flash memory, read-only memory (ROM), programmable read-only memory (PROM), erasable programmable read-only memory (EPROM), electrically erasable programmable read-only memory (EEPROM), magnetic storage, optical storage, solid-state storage, removable storage media, embedded storage, or any combination thereof. The instructions, when executed by one or more processors of receiving mobile phone 10, cause the receiving mobile phone 10 to perform any of the operations described herein, including without limitation monitoring incoming calls, determining unanswered-call counts, placing the receiving mobile phone into the locked state, transmitting messages including the appropriate unlock code or a geographic location, removing the locked state upon any of the unlock conditions described herein, transmitting a control signal to a network device, detecting tamper conditions, deduplicating outgoing messages, and persisting counter and lockout data across restarts. Distribution of the instructions on a non-transitory computer-readable medium, including by way of an application distribution platform such as a mobile application store, falls within the scope of the present disclosure.

What is claimed is:

1. A mobile phone control system, comprising:
a receiving mobile phone including a display, a user interface, and a processor that is configured to implement software instructions, wherein the processor of the receiving mobile phone is configured to implement software instructions for: determining that a predetermined number of calls was made to the receiving mobile phone from an initiating mobile phone number, where the initiating mobile phone number is one of one or more designated mobile phone numbers, that each of the predetermined number of calls was made within a predefined time interval, and that none of the predetermined number of calls was answered; in response to determining that none of the predetermined number of calls was answered within the predefined time interval, automatically placing the receiving mobile phone into a locked state, and automatically transmitting an appropriate unlock code to the initiating mobile phone number; wherein when the receiving mobile phone is in the locked state the receiving mobile phone cannot place an outgoing call to any telephone number other than one of the designated mobile phone numbers, cannot transmit an instant message to any number other than one of the designated mobile phone numbers, and cannot connect to a local network or an Internet, but remains capable of contacting emergency services; and removing the locked state of the receiving mobile phone upon an entry of the appropriate unlock code.

2. The mobile phone control system of claim 1, wherein the appropriate unlock code is entered by a user of the receiving mobile phone after it has been transmitted to the receiving mobile phone from the initiating mobile phone number.

3. The mobile phone control system of claim 1, wherein the predetermined number of unanswered calls is 2-5, and the predetermined time interval is 1-10 minutes.

4. The mobile phone control system of claim 1, wherein the predetermined number of unanswered calls is 2.

5. The mobile phone control system of claim 1, wherein after determining that a first call from the initiating mobile phone number is not answered, the receiving mobile phone is further configured to display a missed call notification.

6. The mobile phone control system of claim 1, wherein after placing the receiving mobile phone in the locked state, the receiving mobile phone is further configured to display a locked state notification.

7. The mobile phone control system of claim 1, wherein after placing the receiving mobile phone in the locked state, the receiving mobile phone is further configured to transmit an additional lock signal to one or more additional electronic devices thereby placing the one or more additional electronic devices into a locked state.

8. The mobile phone control system of claim 7, wherein the receiving mobile phone is further configured such that transmitting the additional lock signal includes transmitting the additional lock signal to one or more of an additional mobile phone, an electronic tablet, a personal computer, and a gaming console.

9. The mobile phone control system of claim 1, wherein upon entering the locked state the receiving mobile phone is further configured to transmit a GPS location pin for a receiving mobile phone location to the initiating mobile phone number.

10. A method of locking a receiving mobile phone, comprising:
receiving, by the receiving mobile phone, a predetermined number of calls from an initiating mobile phone number, where the initiating mobile phone number is one of one or more designated mobile phone numbers; determining, by the receiving mobile phone, that each of the predetermined number of calls from the initiating mobile phone number was received within a predefined time interval; determining, by the receiving mobile phone, that none of the predetermined number of calls from the initiating mobile phone number was answered; in response to determining that none of the predetermined number of calls from the initiating mobile phone number was answered within the predefined time interval, automatically placing the receiving mobile phone into a locked state; wherein when the receiving mobile phone is in the locked state the receiving mobile phone cannot place an outgoing call to any telephone number other than one of the designated mobile phone numbers, cannot transmit an instant message to any number other than one of the designated mobile phone numbers, and cannot connect to a local network or an Internet, but remains capable of contacting emergency services; and automatically transmitting, by the receiving mobile phone, an appropriate unlock code to the initiating mobile phone number, wherein the receiving mobile phone is configured to remove the locked state of the receiving mobile phone upon the appropriate unlock code being entered at the receiving mobile phone.

11. The method of claim 10, wherein the predetermined number of unanswered calls is 2-5 calls, and the predetermined time interval is 1-10 minutes.

12. The method of claim 10, further comprising, after a first of the predetermined number of calls received from the initiating mobile phone number is not answered, displaying by the receiving mobile phone a missed call notification.

13. The method of claim 10, wherein after the receiving mobile phone is placed into the locked state, displaying by the receiving mobile phone a locked state notification.

14. The method of claim 10, further comprising automatically transmitting, by the receiving mobile phone, an additional lock signal to one or more additional electronic devices thereby placing the one or more additional electronic devices into a locked state.

15. The method of claim 14, wherein transmitting the additional lock signal includes transmitting the additional lock signal to one or more of an additional mobile phone, an electronic tablet, a personal computer, and a gaming console.

16. The method of claim 10, further comprising entering the appropriate unlock code in the receiving mobile phone after receiving the appropriate unlock code from the initiating mobile phone number, and thereby removing the locked state of the receiving mobile phone.

17. The method of claim 10, further comprising transmitting a GPS location pin corresponding to a receiving mobile phone location to the initiating mobile phone number.

18. A mobile phone control system comprising a receiving mobile phone including a processor configured to implement software instructions for:
monitoring incoming calls from one or more pre-approved emergency contact numbers; determining that a predetermined number of calls from one of the pre-approved emergency contact numbers was not answered within a predefined time interval; in response, automatically placing the receiving mobile phone into a restricted operating state wherein outgoing communications are limited to the pre-approved emergency contact numbers and emergency services; automatically transmitting a message to the pre-approved emergency contact number from which the unanswered calls originated, the message comprising at least one of: an unlock code, a geographic location of the receiving mobile phone, or both; removing the restricted operating state upon satisfaction of at least one of: entry of the unlock code at the receiving mobile phone, completion of a voice call of at least a minimum duration between the receiving mobile phone and one of the pre-approved emergency contact numbers, or expiration of a predetermined maximum duration of the restricted operating state; and wherein the monitoring, determining, restricting, transmitting, and removing are performed locally on the receiving mobile phone without requiring a controlling application on a separate device, a remote server, or a cloud-based service for safety operation.

19. The system of claim 18, wherein the processor is further configured to, upon placing the receiving mobile phone into the restricted operating state, automatically transmit a control signal to a network device accessible on a local network, the control signal causing the network device to restrict or disable network access for one or more connected devices.

20. The system of claim 19, wherein the processor determines whether to transmit the control signal based on a comparison of one or more characteristics of a currently connected wireless network against stored network identification data, the characteristics comprising one or more of: a network name, a hardware address of an access point, or a network gateway address.

21. The system of claim 19, wherein, upon removing the restricted operating state, the processor automatically transmits a restore signal to the network device causing the network device to re-enable network access.

22. The system of claim 18, wherein the restricted operating state is removed when the receiving mobile phone places or receives a voice call to or from one of the pre-approved emergency contact numbers and the voice call is maintained for at least a minimum call duration.

23. The system of claim 18, wherein the restricted operating state is automatically removed after a maximum lockdown duration regardless of whether the unlock code has been entered, the maximum lockdown duration being configured during initial setup of the system.

24. The system of claim 18, wherein the geographic location is determined at the time the restricted operating state is initiated and is transmitted as a single location fix, and wherein no continuous location tracking, location history, or periodic location updates are performed.

25. The system of claim 18, wherein the processor is further configured so that upon the receiving mobile phone being powered on, a temporary monitoring period of a predetermined duration is initiated during which receipt of a predetermined command message from one of the pre-approved emergency contact numbers causes the receiving mobile phone to be placed into the restricted operating state, and wherein the temporary monitoring period closes automatically upon expiration of the predetermined duration or upon processing of the predetermined command message, whichever occurs first.

26. The system of claim 18, wherein the processor is further configured to detect one or more conditions indicative of an attempt to bypass the system, the conditions comprising one or more of: the receiving mobile phone starting in a restricted diagnostic mode, a development or debugging interface being enabled, or the receiving mobile phone being restarted more than a predetermined number of times within a predetermined period; and in response to detecting one or more of the conditions, automatically transmitting an alert to one or more of the pre-approved emergency contact numbers.

27. The system of claim 26, wherein repeated restarts of the receiving mobile phone within a short period result in progressively increasing delays before the system resumes normal operation, thereby discouraging repeated restarts as a bypass technique.

28. The system of claim 18, wherein upon removing the restricted operating state, a cooldown period is initiated during which the system will not re-enter the restricted operating state in response to additional unanswered calls, thereby preventing repeated immediate re-triggering.

29. The system of claim 18, wherein the software instructions are registered as a device administrator on the receiving mobile phone such that deactivation of the device administrator privilege is required prior to removal of the software instructions, and wherein attempted deactivation triggers a notification to one or more of the pre-approved emergency contact numbers.

30. The system of claim 18, wherein determining that calls were not answered comprises monitoring notifications generated by a telephony application on the receiving mobile phone, without requiring direct access to a call log database.

31. The system of claim 18, wherein determining that calls were not answered comprises receiving call event data from a call screening interface provided by an operating system of the receiving mobile phone.

32. The system of claim 18, wherein determining that calls were not answered comprises employing two or more detection methods in a prioritized sequence, such that if a primary detection method is unavailable or restricted by an operating system of the receiving mobile phone, a secondary detection method is employed.

33. The system of claim 18, wherein the processor is configured to ensure that the message transmitted upon entering the restricted operating state is transmitted exactly once per restricted operating state event, employing one or more deduplication mechanisms to prevent duplicate transmissions regardless of system restarts or retries.

34. The system of claim 18, wherein a count of unanswered calls persists across restarts of the receiving mobile phone, such that powering off and powering on the receiving mobile phone does not reset the count.

35. The system of claim 18, wherein entry of an incorrect unlock code a predetermined number of times results in a temporary lockout period during which no further unlock code entries are accepted.

36. A method of controlling a receiving mobile phone, comprising:
monitoring, by the receiving mobile phone, incoming calls from one or more pre-approved emergency contact numbers; determining that a predetermined number of calls from one of the pre-approved emergency contact numbers was not answered within a predefined time interval; in response, automatically placing the receiving mobile phone into a restricted operating state limiting outgoing communications to the pre-approved emergency contact numbers and emergency services; automatically transmitting a message comprising at least one of an unlock code and a geographic location to the pre-approved emergency contact number from which the unanswered calls originated; removing the restricted operating state upon satisfaction of at least one of: entry of the unlock code, completion of a voice call of at least a minimum duration with one of the pre-approved emergency contact numbers, or expiration of a predetermined maximum duration; wherein all monitoring, determining, restricting, and removing are performed locally on the receiving mobile phone.

37. The system of claim 18, wherein placing the receiving mobile phone into the restricted operating state comprises rendering, by the receiving mobile phone, a lockdown user interface above other applications running on the receiving mobile phone, the lockdown user interface restricting user input to one or more controls for placing a call to one of the pre-approved emergency contact numbers, entering the unlock code, and contacting emergency services.

38. The system of claim 19, wherein the control signal includes authentication using stored administrator credentials for the network device, and wherein the stored administrator credentials are encrypted on the receiving mobile phone using hardware-backed encryption.

39. The system of claim 34, wherein the count of unanswered calls is persisted in encrypted storage backed by a hardware-backed keystore of the receiving mobile phone, such that the persisted count is protected against extraction by an unprivileged user of the receiving mobile phone.

40. The method of claim 36, wherein placing the receiving mobile phone into the restricted operating state comprises rendering a lockdown user interface above other applications running on the receiving mobile phone, the lockdown user interface restricting user input to one or more controls for placing a call to one of the pre-approved emergency contact numbers, entering the unlock code, and contacting emergency services.

41. A non-transitory computer-readable medium storing instructions that, when executed by one or more processors of a receiving mobile phone, cause the receiving mobile phone to perform operations comprising:
monitoring incoming calls from one or more pre-approved emergency contact numbers; determining that a predetermined number of calls from one of the pre-approved emergency contact numbers was not answered within a predefined time interval; in response, automatically placing the receiving mobile phone into a restricted operating state limiting outgoing communications to the pre-approved emergency contact numbers and emergency services; automatically transmitting a message comprising at least one of an unlock code and a geographic location to the pre-approved emergency contact number from which the unanswered calls originated; and removing the restricted operating state upon satisfaction of at least one of: entry of the unlock code at the receiving mobile phone, completion of a voice call of at least a minimum duration between the receiving mobile phone and one of the pre-approved emergency contact numbers, or expiration of a predetermined maximum duration of the restricted operating state.

42. The non-transitory computer-readable medium of claim 41, wherein the instructions further cause the receiving mobile phone to, upon placing the receiving mobile phone into the restricted operating state, automatically transmit a control signal to a network device accessible on a local network, the control signal causing the network device to restrict or disable network access for one or more connected devices.

43. The non-transitory computer-readable medium of claim 41, wherein the instructions further cause the receiving mobile phone to render a lockdown user interface above other applications running on the receiving mobile phone, the lockdown user interface restricting user input to one or more controls for placing a call to one of the pre-approved emergency contact numbers, entering the unlock code, and contacting emergency services.

44. The non-transitory computer-readable medium of claim 41, wherein the instructions further cause the receiving mobile phone to detect one or more conditions indicative of an attempt to bypass the operations, the conditions comprising one or more of: the receiving mobile phone starting in a restricted diagnostic mode, a development or debugging interface being enabled, or the receiving mobile phone being restarted more than a predetermined number of times within a predetermined period; and, in response to detecting one or more of the conditions, transmit an alert to one or more of the pre-approved emergency contact numbers.
